(19) United States
(12) Patent Application Publication
(10) Pub. No.: US 2008/0234427 A1
(43) Pub. Date: Sep. 25, 2008

(54) Utilization of Radiohardenable Resins Based on Ketone and/or Urea Aldehyde Resins

(75) Inventors: Patrick Glockner, Haltern am See (DE); Lutz Mindach, Marl (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/586,587

(22) PCT Filed: Dec. 7, 2004
(86) PCT No.: PCT/EP2004/053315

§ 371 Date: Jul. 20, 2006

(30) Foreign Application Priority Data
Feb. 3, 2004 (DE) 10 2004 005 207.7

(51) Int. Cl. C08L 61/00; C08L 67/00

(52) U.S. Cl. 524/592; 525/509; 525/521; 525/418; 525/153; 525/154; 524/597

(57) ABSTRACT

The invention relates to the use of radiation-curable resins based on ketone-aldehyde and urea-aldehyde resins.

The invention relates to the use of radiation-curable resins based on ketone-aldehyde and urea-aldehyde resins.

Radiation-curable coating materials have increasingly gained in importance within recent years, owing not least to the low VOC (volatile organic compounds) content of these systems.

The film-forming components in the coating material are of relatively low molecular mass and hence of low viscosity, so that there is no need for high fractions of organic solvents. Durable coatings are obtained by the formation, following application of the coating material, of a high molecular mass, polymeric network by means of crosslinking reactions initiated, for example, by electron beams or UV light.

Hard resins such as, for example, ketone-aldehyde resins are used in coating materials, for example, as additive resins in order to enhance certain properties such as initial drying rate, gloss, hardness or scratch resistance. Owing to their relatively low molecular weight, customary ketone-aldehyde resins possess a low melt viscosity and solution viscosity and therefore also serve as film-forming functional fillers in coating materials.

Ketone-aldehyde resins normally possess hydroxyl groups and can therefore be crosslinked only with, for example, polyisocyanates or amine resins. These crosslinking reactions are usually initiated and/or accelerated thermally.

For radiation-initiated crosslinking reactions, in accordance with cationic and/or free-radical reaction mechanisms, the ketone-aldehyde resins are not suitable.

Accordingly, the ketone-aldehyde resins are normally added to radiation-curable coating systems as, for example, a film-forming passive, i.e., noncrosslinking component. Owing to the uncrosslinked resin fractions, the resistance of such coatings to gasoline, chemicals or solvents, for example, is often relatively low.

WO 95/17476, DE 23 45 624, EP 736 074, DE 28 47 796, DD 24 0318, DE 24 38 724, and JP 09143396 describe the use of ketone-aldehyde resins and ketone resins, e.g., cyclohexanone-formaldehyde resins, in radiation-curable systems. Radiation-induced crosslinking reactions of these resins are not described.

EP 0 902 065 describes the use of nonradiation-curable resins formed from urea (derivatives), ketone or aldehydes as an added component in a mixture with radiation-curable resins.

DE 24 38 712 describes radiation-curing printing inks composed of film-forming resins, ketone resins and ketone-formaldehyde resins, and polymerizable components such as polyfunctional acrylate esters of polyhydric alcohols. To the skilled worker it is obvious that radiation-induced crosslinking reaction of the modified ketone-aldehyde resins and ketone resins can only come about through the use of unsaturated fatty acids. It is known, however, that resins having a higher oil content tend toward, for example, unwanted yellowing and thus their use in high-quality coatings is limited.

U.S. Pat. No. 4,070,500 describes the use of nonradiation-curable ketone-formaldehyde resins as a film-forming component in radiation-curable inks.

It was an object of the present invention to find radiation-curable crosslinkable resins for use in coating materials, adhesives, inks, including printing inks, polishes, varnishes, pigment pastes and masterbatches, fillers, sealants and insulants and/or cosmetic articles which produce durable and robust coatings, seals and adhesive bonds, are insoluble after crosslinking, and possess great hardness and abrasion resistance, a high gloss, and a high stability toward hydrolysis.

Surprisingly it has been possible to achieve this object by using ketone-aldehyde resins and/or urea-aldehyde resins containing ethylenically unsaturated moieties as a main, base or additional component in radiation-curing coating materials, adhesives, inks, including printing inks, polishes, varnishes, pigment pastes and masterbatches, fillers, sealants and insulants and/or cosmetic articles.

It has been found that the use of the radiation-curable resins of the invention based on ketone-aldehyde resins and/or urea-aldehyde resins as a main, base or additional component in radiation-curing coating materials, adhesives, inks, including printing inks, polishes, varnishes, pigment pastes and masterbatches, fillers, sealants and insulants and/or cosmetic articles brings about a reduction in viscosity, thereby making it possible very largely to omit low molecular mass constituents—particularly volatile organic solvents which may possibly also contain reactive groups (and are then known as reactive diluents)—which is desirable on environmental and toxicological reasons.

The use of the radiation-curable resins of the invention based on ketone-aldehyde resins and/or urea-aldehyde resins as a main, base or additional component in radiation-curing coating materials, adhesives, inks, including printing inks, polishes, varnishes, pigment pastes and masterbatches, fillers, sealants and insulants and/or cosmetic articles results in greater gloss and greater hardness and also abrasion resistance, improved chemical resistance and solvent resistance, and very high stability toward hydrolysis at the same time.

Additionally there is an improvement in the adhesion to substrates such as metals, plastics, wood, paper, textiles, and glass, for example, and also mineral substrates, thereby enhancing the protection afforded to these substrates, through an increase in corrosion resistance, for example. There is also an increase in the intercoat adhesion, thereby improving the adhesion of further applied coats.

Both pigment wetting and stabilization of the pigments are improved. It is possible to achieve the same color shade and color strengths with a smaller amount of pigment if the products according to the invention are used. This is particularly advantageous not least on economic reasons, since not only high-priced pigments but also additive wetting and stabilizing agents can be at least reduced.

The invention provides for the use of radiation-curable resins essentially comprising
A) at least one ketone-aldehyde resin
   and/or
B) at least one urea-aldehyde resin
   and
C) at least one compound comprising at least one ethylenically unsaturated moiety having at the same time at least one moiety which is reactive toward A) and/or B),
   as a main component, base component or additional component in radiation-curing coating materials, adhesives, inks, including printing inks, polishes, varnishes, pigment pastes and masterbatches, fillers, sealants and insulants and/or cosmetic articles.

The invention also provides for the use of radiation-curable resins obtained by polymer-analogously reacting
A) at least one ketone-aldehyde resin
   and/or
B) at least one urea-aldehyde resin
   and
C) at least one compound comprising at least one ethylenically unsaturated moiety and at the same time at least one moiety which is reactive toward A) and/or B),
   as a main component, base component or additional component in radiation-curing coating materials, adhesives, inks, including printing inks, polishes, varnishes, pigment pastes and masterbatches, fillers, sealants and insulants and/or cosmetic articles.

Particular preference is given to the use of the radiation-curable resins as a main component, base component or additional component in radiation-curing fillers, primers, surfacers, base-coat, topcoat, and clearcoat materials, particularly on metals, plastics, wood, paper, textiles and glass and also on mineral substrates.

Besides the radiation-curable resins it is possible for other oligomers and/or polymers, selected from the group consisting of polyurethanes, polyesters, polyacrylates, polyolefins, natural resins, epoxy resins, silicone oils and silicone resins, amine resins, fluoro polymers, and derivatives thereof, to be present, alone or in combination. Depending on the desired properties and the nature of the application it is possible for the amount of the further oligomers and/or polymers to be between 98% and 5%.

The radiation-curable resins may also comprise auxiliaries and additives selected from inhibitors, organic solvents, with or without unsaturated moieties, surface-active substances, oxygen scavengers and/or free-radical scavengers, catalysts, light stabilizers, color brighteners, photoinitiators, photosensitizers, thixotropic agents, antiskinning agents, defoamers, dyes, pigments, fillers, and dulling agents. The amount varies greatly according to the field of use and nature of the auxiliary and additive.

The text below describes in more detail the radiation-curable resins of the invention based on ketone-aldehyde resins and/or urea-aldehyde resins.

Suitable ketones for preparing the ketone-aldehyde resins (component A) include all ketones, especially acetone, acetophenone, methyl ethyl ketone, tert-butyl methyl ketone, heptan-2-one, pentan-3-one, methyl isobutyl ketone, cyclopentanone, cyclododecanone, mixtures of 2,2,4- and 2,4,4-trimethylcyclopentanone, cycloheptanone and cyclooctanone, cyclohexanone and all alkyl-substituted cyclohexanones having one or more alkyl radicals containing in total 1 to 8 carbon atoms, individually or in a mixture. Examples that may be mentioned of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone.

In general, however, any of the ketones said in the literature to be suitable for ketone resin syntheses, more generally all C—H-acidic ketones, can be used. Preference is given to ketone-aldehyde resins based on the ketones acetophenone, cyclohexanone, 4-tert-butylcyclohexanone, 3,3,5-trimethylcyclohexanone, and heptanone, alone or in a mixture. Suitable aldehyde components of the ketone-aldehyde resins (component A) include in principle linear or branched aldehydes, such as formaldehyde, acetaldehyde, n-butyraldehyde and/or isobutyraldehyde, valeraldehyde, and dodecanal. In general it is possible to use any of the aldehydes said in the literature to be suitable for ketone resin syntheses. It is preferred, however to use formaldehyde, alone or in mixtures.

The requisite formaldehyde is normally used in the form of an aqueous or alcoholic (e.g. methanol or butanol) solution with a strength of from about 20 to 40% by weight. Other forms of formaldehyde, such as para-formaldehyde or trioxane, for example, are likewise possible.

Aromatic aldehydes, such as benzaldehyde, can likewise be present in a mixture with formaldehyde.

Particularly preferred starting compounds used for component A) are acetophenone, cyclohexanone, 4-tert-butylcyclohexanone, 3,3,5-trimethylcyclohexanone, and heptanone, alone or in a mixture, and formaldehyde.

The preparation and the monomers for component B) are described in EP 0 271 776:

As component B) use is made of urea-aldehyde resins using a urea of the general formula (i)

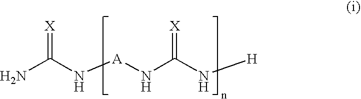

in which X is oxygen or sulfur, A is an alkylene radical, and n is from 0 to 3, with from 1.9 (n+1) to 2.2 (n+1) mol of an aldehyde of the general formula (ii)

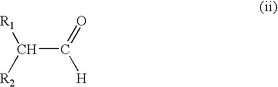

in which R₁ and R₂ are hydrocarbon radicals (e.g. alkyl, aryl and/or alkylaryl radicals) each having up to 20 carbon atoms
and/or formaldehyde.

Suitable ureas of the general formula (I) where n=0 are, for example, urea and thiourea, where n=1, methylenediurea, ethylenediurea, tetramethylenediurea and/or hexamethylenediurea and also mixtures thereof. Preference is given to urea.

Suitable aldehydes of the general formula (II) are, for example, isobutyraldehyde, 2-methylpentanal, 2-ethylhexanal, and 2-phenylpropanal, and also mixtures thereof. Preference is given to isobutyraldehyde.

Formaldehyde can be used in aqueous form, which may also include, in part or entirely, alcohols such as methanol or ethanol, for example, or else as paraformaldehyde and/or trioxane.

Generally speaking, all monomers described in the literature for the preparation of aldehyde-urea resins are suitable.

Typical compositions are described, in, for example, DE 27 57 220, DE-A 27 57 176, and EP 0 271 776.

The radiation-curable resins on which the invention is based are obtained by polymer-analogous reaction of the ketone-aldehyde resins and/or of the urea-aldehyde resins, in the melt or in a suitable solvent solution, with component C). Suitability as component C) is possessed by maleic anhydride, (meth)acrylic acid derivatives such as (meth)acryloyl chloride, glycidyl (meth)acrylate, (meth)acrylic acid and/or the low molecular mass alkyl esters and/or anhydrides thereof, alone or in a mixture. It is also possible to obtain radiation-curable resins by reacting the ketone-aldehyde resins and urea-aldehyde resins with isocyanates possessing an ethylenically unsaturated moiety, such as (meth)acryloyl isocyanate, α,α-dimethyl-3-isopropenylbenzyl isocyanate, (meth)acryloylalkyl isocyanate with alkyl spacers possessing from 1 to 12, preferably from 2 to 8, more preferably from 2 to 6 carbon atoms, such as methacryloylethyl isocyanate and methacryloylbutyl isocyanate, for example. Further reaction products which have proven suitable are those of hydroxyalkyl (meth)acrylates whose alkyl spacers have from 1 to 12, preferably from 2 to 8, more preferably from 2 to 6 carbon atoms and diisocyanates such as, for example, cyclohexane diisocyanate, methylcyclohexane diisocyanate, ethylcyclohexane diisocyanate, propylcyclohexane diisocyanate, methyldiethylcyclohexane diisocyanate, phenylene diisocyanate, tolylene diisocyanate, bis(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyloctane 1,8-diisocyanate (TIN), decane di- and triisocyanate, undecane di- and triisocyanate, dodecane di- and triisocyanates, isophorone diisocyanate (IPDI), bis(isocyanatomethylcyclohexyl)methane (H₁₂MDI), isocyanatomethylmethylcyclohexyl isocyanate, 2,5(2,6)-bis(isocyanatomethyl)bicyclo[2.2.1]heptane (NBDI), 1,3-bis(isocyanatomethyl)cyclohexane (1,3-H₆-XDI) or 1,4-bis(isocyanatomethyl)cyclohexane (1,4-H₆-XDI), alone or in a mixture. Examples that may be mentioned include the reaction products in a 1:1 molar ratio of hydroxyethyl acrylate and/or hydroxyethyl methacrylate with isophorone diisocyanate and/or H₁₂MDI and/or HDI.

Another preferred class of polyisocyanates are the compounds having more than two isocyanate groups per molecule which are prepared by trimerizing, allophanatizing, biuretizing and/or urethaneizing the simple diisocyanates, examples being the reaction products of these simple diisocyanates, such as IPDI, HDI and/or HMDI, for example, with polyhydric alcohols (e.g., glycerol, trimethylolpropane, pentaerythritol) and/or polyfunctional polyamines or else the triisocyanurates obtainable by trimerizing the simple diisocyanates, such as IPDI, HDI, and HMDI, for example.

If desired it is possible to use a suitable catalyst for preparing the resins of the invention. Suitable compounds are all those known in the literature which accelerate an OH—NCO reaction, such as diazabicyclooctane (DABCO) or dibutyltin dilaurate (DBTL) for example.

The functionality of the resins obtained ranges from low to high in accordance with the ratio of the reactants to one another. Through the choice of reactants it is also possible to set the subsequent hardness of the crosslinked film. If, for example, a hard resin such as cyclohexanone-formaldehyde resin is reacted with α,α-dimethyl-3-isopropenylbenzyl isocyanate, the resulting products are harder than those obtained through the use of (meth)acryloylethyl isocyanate and/or hydroxyethyl acrylate-isophorone diisocyanate adducts; the flexibility, however, is then lower. It has also been found that the reactivity of ethylenically unsaturated compounds with little steric hindrance—such as of hydroxyethyl acrylate, for example—is higher than in the case of those which are sterically hindered, such as α,α-dimethyl-3-isopropenylbenzyl isocyanate, for example.

In principle it is possible to consider incorporating ethylenically unsaturated moieties even during the actual preparation of the ketone-aldehyde and/or urea-aldehyde resins. By way of the proportional use of suitable monomers, such as polymerizable ketones having olefinic double bonds, for example, any desired degrees of functionalization can be set. The disadvantage of this procedure lies in the limited availability of suitable monomer building blocks.

It is also possible to replace some of the ketone-aldehyde resins A) and/or urea-aldehyde resins B) by further hydroxy-functionalized polymers such as hydroxy-functional polyethers, polyesters and/or polyacrylates, for example. In this case, mixtures of these polymers with the ketone-aldehyde resins and/or urea-aldehyde resins can be reacted polymer-analogously with component C). It has been found that first of all it is also possible to prepare adducts of the ketone-aldehyde resins and/or urea-aldehyde resins with, for example, hydroxy-functional polyethers, polyesters and/or polyacrylates using the abovementioned diisocyanates and/or triisocyanates, and only then are these adducts reacted polymer-analogously with component C). In contrast to the “plain” ketone-aldehyde resins and/or urea-aldehyde resins it is possible by this means better to set properties such as flexibility and hardness, for example. The further hydroxy-functional polymers generally possess molecular weights Mn of between 200 and 10 000 g/mol, preferably between 300 and 5 000 g/mol.

The resins on which the invention is based are prepared in the melt or in a suitable, organic solvent solution of the ketone-aldehyde resins and/or urea-aldehyde resins. Said organic solvent may if desired likewise possess unsaturated moieties, in which case it acts directly as a reactive diluent in the subsequent application.

For this purpose, in one preferred embodiment I,

the compound C), in the presence if desired of a suitable catalyst, is added to the solution or melt of the ketone-aldehyde resins A) and/or urea-aldehyde resins B).

The temperature of the reaction is selected in accordance with the reactivity of component C). Where isocyanates are used as component C), suitable temperatures have been found to be between 30 and 150° C., preferably between 50 and 140° C.

The solvent that may be present can be separated off if desired after the end of the reaction, in which case a powder of the product of the invention is generally obtained.

It has proven advantageous to react 1 mol of the ketone-aldehyde resins and/or urea-aldehyde resins—based on Mₙ—with from 0.5 to 15 mol, preferably from 1 to 10 mol, in particular from 2 to 8 mol of the unsaturated compound (component C).

In a preferred embodiment II

the compound C), in the presence if desired of a suitable catalyst, is added to the solution or melt of the ketone-aldehyde resins A) and/or urea-aldehyde resins B) and the hydroxy-functional polymer, such as polyether, polyester and/or polyacrylate, for example.

The temperature of the reaction is selected in accordance with the reactivity of component C). Where isocyanates are used as component C), suitable temperatures have been found to be between 30 and 150° C., preferably between 50 and 140° C.

The solvent that may be present can be separated off if desired after the end of the reaction, in which case a powder of the product of the invention is generally obtained.

It has proven advantageous to react 1 mol of the ketone-aldehyde resins and/or urea-aldehyde resins and/or additional polymers—based on Mₙ—with from 0.5 to 15 mol, preferably from 1 to 10 mol, in particular from 2 to 8 mol of the unsaturated compound (component C).

In a preferred embodiment III

a di- and trifunctional isocyanate is added to the solution or melt of the ketone-aldehyde resins A) and/or urea-aldehyde resins B) and the hydroxy-functional polymer, such as polyether, polyester and/or polyacrylate, for example and a hydroxy-functional preadduct is prepared. Only then is the compound C), in the presence if desired of a suitable catalyst, added.

The temperature of the reaction is selected in accordance with the reactivity of component C). Where isocyanates are used as component C), suitable temperatures have been found to be between 30 and 150° C., preferably between 50 and 140° C.

The solvent that may be present can be separated off if desired after the end of the reaction, in which case a powder of the product of the invention is generally obtained.

It has proven advantageous to react 1 mol of the ketone-aldehyde resins and/or urea-aldehyde resins and/or additional polymers—based on Mₙ—with from 0.5 to 15 mol, preferably from 1 to 10 mol, in particular from 2 to 8 mol of the unsaturated compound (component C).

In the presence of suitable photoinitiators, and in the presence if desired of suitable photosensitizers, these resins can be converted by irradiation into polymeric, insoluble networks which, depending on the level of ethylenically unsaturated groups present, produce elastomers to thermosets.

The examples which follow are intended to illustrate the invention but not to restrict its scope of application:

### EXAMPLES

### Preparation of a Radiation-Crosslinking Resin (UV 22)

Synthesis takes place by reaction of 1 mol of an anhydrous cyclohexanone-formaldehyde resin (water content <0.2% by weight, OHN=105 mg KOH/g (acetic anhydride method), Mn˜650 g/mol, against polystyrene) with 1.2 mol of a reaction product of IPDI and hydroxyethyl acrylate in a ratio of 1:1 in the presence of 0.2% (on resin) of 2,6-bis(tert-butyl)-4-methylphenol (Ralox BHT, Degussa AG) and 0.1% (on resin) of dibutyltin dilaurate, 65% strength in methoxypropyl acetate, at 80° C. under nitrogen in a three-necked flask with stirrer, reflux condenser, and temperature sensor until an NCO number of less than 0.1 is reached. The pale, clear solution obtained possesses a dynamic viscosity of 11.5 Pass.

### Use Examples

The base resin (UV 20) used was an adduct of trimethylolpropane, IPDI, Terathane 650 and hydroxyethyl acrylate, as a 70% strength solution in MOP acetate, viscosity at 23° C.=19.2 Pas.

### Viscosities of the Different Systems in 50% Form in MOP Acetate Without Photoinitiator

| Number | Mixing ratio | dyn. Viscosity |
|---|---|---|
| BXXVII/xxx/03 | Solids | 23° C. |
| Mixtures | | |
| 481 | A-UV 20 | 775 mPas |
| 500 | A-UV 20:A-UV 22 = 95:5 | 715 mPas |
| 501 | A-UV 20:A-UV 22 = 90:10 | 710 mPas |
| 502 | A-UV 20:A-UV 22 = 80:20 | 590 mPas |

As the proportion of the products of the invention goes up there is a fall in the dynamic viscosity of the formulations.

### Summary of the Coatings Data Obtained

Darocure 1173 (for amount see table) was added to the mixtures and they were drawn down to metal panels using a doctor blade. The systems contain solvent; therefore initial drying was carried out in a forced-air oven at 80° C. for 30 minutes. The films were then cured by means of UV light (medium-pressure mercury lamp, 70 W/optical filter 350 nm) (3×6 s).

| | Resin mix. | 1173 | | Coatings data | | | | | |
|---|---|---|---|---|---|---|---|---|---|
| Coating No. | based on | [% based | NVC | | CH/ | | | | |
| BXXVII/xxx/03 | resin | on resin] | [%] | FT μ | Tesa | HB | EC | HK | Flow |
| 481 | A-UV 20 | 1.50 | 50.4 | 31-39 | 2B/ | n.m. | n.m. | 38 | minimally restless |
| | | | | | 5B | | | | tacky |
| 500 | A-UV 20 95 | 1.50 | 50.4 | 31-34 | 0-1B/ | 63 | n.m. | 39 | ok |
| | A-UV 22 5 | | | | 5B | | | | |
| 501 | A-UV 20 90 | 1.50 | 50.4 | 27-32 | 0-1B/ | 67 | n.m. | 43 | minimally restless |
| | A-UV 22 10 | | | | 5B | | | | |
| 502 | A-UV 20 80 | 1.50 | 50.4 | 26-31 | 0B/ | 73 | >10., 5 | 45 | minimally restless |
| | A-UV 22 20 | | | | 3B | | | | |

1173: Darocur 1173

Chemical crosslinking of the products according to the invention increases the hardness and the adhesion. In addition the films become less tacky and the values for the Erichson cupping are improved.

### Abbreviations

DBTL: dibutyltin dilaurate

EC: Erichson cupping

HB: Buchholz hardness

HK: König pendulum hardness

IPDI: isophorone diisocyanate

MOP acetate: methoxypropyl acetate

NVC: nonvolatile constituents

FT: film thickness

CH: cross-hatch

1. (canceled)

2. A method of forming an adhesive, an ink, a polish, a varnish, a pigment paste, a pigment masterbatch, a filler, a sealant, an insulant, or a cosmetic article comprising forming the adhesive, the ink, the polish, the varnish, the pigment paste, the pigment masterbatch, the filler, the sealant, the insulant, or the cosmetic article with a radiation-curable resin, wherein the radiation-curable resin is obtained by polymer-analogously reacting
A) at least one ketone-aldehyde resin or
B) at least one urea-aldehyde resin or
A and B) at least one ketone-aldehyde resin and at least one urea-aldehyde resin, and
C) at least one compound comprising at least one ethylenically unsaturated moiety and at least one moiety which is reactive toward A), B), or A) and B).

3. The method of claim 2, wherein the radiation curable resin is obtained by polymer-analogously reacting
A) the at least one ketone-aldehyde resin or
B) the at least one urea-aldehyde resin or
the A and B) at least one ketone-aldehyde resin and at least one urea-aldehyde resin and
C) the at least one compound comprising at least one ethylenically unsaturated moiety and at the same time at least one moiety which is reactive toward A), B), or A and B), and at least one further hydroxyl-functionalized polymer.

4. The method of claim 3, wherein the at least one further hydroxyl-functionalized polymer is selected from the group consisting of at least one polyether, at least one polyester, at least one polyacrylate, and mixtures thereof.

5. The method of claim 3, wherein the at least one ketone-aldehyde resin A), the at least one urea-aldehyde resin B), or A) and B) are reacted polymer-analogously with the at least one compound C).

6. The method of claim 3, wherein, first, adducts of the at least one ketone-aldehyde resin A), the at least one urea-aldehyde resin B), or the at least one ketone-aldehyde resin A) and the at least one urea-aldehyde resin B), with the at least one further hydroxyl-functionalized polymer, are prepared with di- and triisocyanates, and these adducts are then reacted polymer-analogously with the at least compound C).

7. The method of claim 2, wherein the polymer-analogously reacting comprises the at least one ketone-aldehyde resin A) and wherein C—H-acidic ketones are used in the at least one ketone-aldehyde resin A).

8. The method of claim 2, wherein the polymer-analogously reacting comprises the at least one ketone-aldehyde resin A), and wherein at least one ketone selected from the group consisting of acetone, acetophenone, methyl ethyl ketone, tert-butyl methyl ketone, heptan-2-one, pentan-3-one, methyl isobutyl ketone, cyclopentanone, cyclododecanone, mixtures of 2,2,4- and 2,4,4-trimethylcyclopentanone, cycloheptanone, cyclooctanone, cyclohexanone and mixtures thereof, is used as a starting material in the at least one ketone-aldehyde resin A).

9. The method of claim 2, wherein the polymer-analogously reacting comprises the at least one ketone-aldehyde resin A), and wherein at least one alkyl-substituted cyclohexanone comprising one or more alkyl radicals comprising in total 1 to 8 carbon atoms is used in the at least one ketone-aldehyde resin A).

10. The method of claim 9, wherein the polymer-analogously reacting comprises the at least one ketone-aldehyde resin A), and wherein at least one ketone selected from the group consisting of 4-tert-amylcyclohexanone, 2-sec-butylcyclohexanone, 2-tert-butylcyclohexanone, 4-tert-butylcyclohexanone, 2-methylcyclohexanone, 3,3,5-trimethylcyclohexanone, and mixtures thereof, is used in the at least one ketone-aldehyde resin.

11. The method of claim 2, wherein the polymer-analogously reacting comprises the at least one ketone-aldehyde resin A), and wherein at least one ketone selected from the group consisting of acetophenone, cyclohexanone, 4-tert-butylcyclohexanone, 3,3,5-trimethylcyclohexanone, heptanone, and mixtures thereof, is used in the at least one ketone-aldehyde resin A).

12. The method of claim 2, wherein the polymer-analogously reacting comprises the at least one ketone-aldehyde resin A), and wherein at least one aldehyde selected from the group consisting of formaldehyde, acetaldehyde, n-butyraldehyde, isobutyraldehyde, valeraldehyde, dodecanal, and mixtures thereof, is used as an aldehyde component in the at least one ketone-aldehyde resin A).

13. The method of claim 2, wherein the polymer-analogously reacting comprises the at least one ketone-aldehyde resin A), and wherein at least one molecule selected from the group consisting of formaldehyde, paraformaldehyde, trioxane, and mixtures thereof, is used as the aldehyde component of the at least one ketone-aldehyde resin A).

14. The method of claim 2, wherein the polymer-analogously reacting comprises the at least one ketone-aldehyde resin A), and wherein at least one ketone selected from the group consisting of acetophenone, cyclohexanone, 4-tert-butylcyclohexanone, 3,3,5-trimethylcyclohexanone, heptanone, and mixtures thereof, and formaldehyde are used as the ketone component and the aldehyde component of the at least one ketone-aldehyde resin A).

15. The method of claim 2, wherein the polymer-analogously reacting comprises the at least one urea-aldehyde resin B), and wherein the at least one urea-aldehyde resin B) comprises urea-aldehyde resins prepared from a urea of the general formula (I) 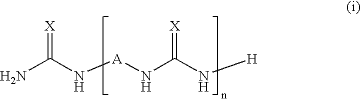
wherein X is oxygen or sulfur, A is an alkylene radical, and n is from 0 to 3, and
from 1.9 (n+1) to 2.2 (n+1) mol of an aldehyde of the general formula (ii) 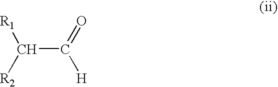
wherein R₁ and R₂ are hydrocarbon radicals each comprising up to 20 carbon atoms,
or from formaldehyde,
or from 1.9 (n+1) to 2.2 (n+1) mol of an aldehyde of the general formula (ii) 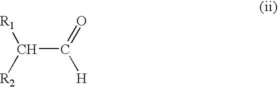
wherein R₁ and R₂ are hydrocarbon radicals each comprising up to 20 carbon atoms, and formaldehyde.

16. The method of claim 2, wherein the polymer-analogously reacting comprises the at least one urea-aldehyde resin B), and wherein the at least one urea-aldehyde resin B) is prepared from at least one molecule selected from the group consisting of urea, thiourea, methylenediurea, ethylenediurea, tetramethylenediurea, hexamethylenediurea, and mixtures thereof.

17. The method of claim 2, wherein the polymer-analogously reacting comprises the at least one urea-aldehyde resin B), and wherein the at least one urea-aldehyde resin B) is prepared from at least one aldehyde selected from the group consisting of isobutyraldehyde, formaldehyde, 2-methylpentanal, 2-ethylhexanal, and 2-phenylpropanal, and mixtures thereof.

18. The method of claim 2, wherein the polymer-analogously reacting comprises the at least one urea-aldehyde resin B, and wherein the at least one urea-aldehyde resin B comprises, in polymerized form, monomers of urea, isobutyraldehyde, and formaldehyde.

19. The method of claim 2, wherein the at least one compound C) comprises maleic acid.

20. The method of claim 2, wherein the at least one compound C) comprises (meth)acrylic acid.

21. The method of claim 2, wherein the at least one compound C) comprises (meth)acryloyl chloride, glycidyl (meth)acrylate, (meth)acrylic acid, low molecular mass alkyl esters thereof, anhydrides thereof, or mixtures of these compounds.

22. The method of claim 2, wherein the at least one compound C) comprises at least one compound selected from the group consisting of preferably (meth)acryoyl isocyanate, α,α-dimethyl-3-isopropenylbenzyl isocyanate, methacryloylethyl isocyanate, methacryloylbutyl isocyanate, and mixtures thereof.

23. The method of claim 2, wherein the at least one compound C) comprises at least one moiety selected from the group consisting of at least one hydroxyalkyl (meth)acrylate comprising an alkyl spacer comprising 1 to 12 carbon atoms, at least one diisocyanate, at least one polyisocyanate, and combinations thereof.

24. The method of claim 23, wherein the at least one compound C) comprises at least one diisocyanate, and wherein the at least one diisocyanate is selected from the group consisting of cyclohexane diisocyanate, methylcyclohexane diisocyanate, ethylcyclohexane diisocyanate, propylcyclohexane diisocyanate, methyldiethylcyclohexane diisocyanate, phenylene diisocyanate, tolylene diisocyanate, bis(isocyanatophenyl)methane, propane diisocyanate, butane diisocyanate, pentane diisocyanate, hexane diisocyanate, heptane diisocyanate, octane diisocyanate, 1,6-diisocyanato-2,4,4-trimethylhexane, 1,6-diisocyanato-2,2,4-trimethylhexane (TMDI), 4-isocyanatomethyloctane 1,8-diisocyanate (TIN), decane di-isocyanate, decane-triisocyanate, undecane di-isocyanate, undecane-triisocyanate, dodecane di-isocyanate, dodecane tri-isocyanate, isophorone diisocyanate (IPDI), bis(isocyanatomethylcyclohexyl)methane (H₁₂MDI), isocyanatomethylmethylcyclohexyl isocyanate, 2,5(2,6)-bis(isocyanatomethyl)bicyclo-[2.2.1]heptane (NBDI), 1,3-bis(isocyanatomethyl)cyclohexane (1,3-H₆-XDI), 1,4-bis(isocyanatomethyl)cyclohexane (1,4-H₆-XDI), and mixtures thereof.

25. The method of claim 23, wherein the at least one compound C) comprises at least one polyisocyanate, and wherein the at least one polyisocyanate is prepared by trimerizing, allophanatizing, biuretizing, urethaneizing, or a combination thereof, simple diisocyanates.

26. The method of claim 2, wherein the at least one compound C) comprises reaction products, in a molar ratio of from 1:1 to 1:1.5, of hydroxyethyl acrylate, hydroxyethyl methacrylate, or hydroxyethyl acrylate and hydroxyethyl methacrylate, reacted with isophorone diisocyanate, H₁₂MDI, HDI, or a combination thereof.

27. The method of claim 2, wherein 1 mol of the at least one ketone-aldehyde resin A), the at least one urea-aldehyde resin B), or A) and B),—based on Mₙ—and from 0.5 to 15 mol of the at least one compound C) are used.

28-29. (canceled)

30. The method of claim 2, wherein further comprising forming the adhesive, the ink, the polish, the varnish, the pigment paste, the pigment masterbatch, the filler, the sealant, the insulant, or the cosmetic article with a material comprising at least one oligomer, at least one polymer, or at least one oligomer and at least one polymer.

31. The method of claim 30, wherein the material is selected from the group consisting of polyurethanes, polyesters, polyacrylates, polyolefins, natural resins, epoxy resins, silicone oils, silicone resins, amine resins, fluoro polymers, and mixtures thereof.

32. The method of claim 2, further comprising forming the adhesive, the ink, the polish, the varnish, the insulant, or the cosmetic article with at least one auxiliary and at least one additive use.

33. The method of claim 32, wherein the at least one auxiliary and the at least one additive are selected from the group consisting of inhibitors, organic solvents, with or without unsaturated moieties, surface-active substances, oxygen scavengers, free-radical scavengers, catalysts, light stabilizers, color brighteners, photoinitiators, photosensitizers, thixotropic agents, antiskinning agents, defoamers, dyes, pigments, fillers, dulling agents, and mixtures thereof.
